(19) United States
(12) Patent Application Publication
(10) Pub. No.: US 2007/0136302 A1
(43) Pub. Date: Jun. 14, 2007

(54) Automated device blog creation

(75) Inventor: Mark D. Zuber, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/299,581

(22) Filed: Dec. 12, 2005

(51) Int. Cl. G06F 17/30

(52) U.S. Cl. 707/10

(57) ABSTRACT

Automated device web log (“blog”) creation is described. Data associated with a computing device is automatically gathered and transmitted to a server. The gathered data may include, but is not limited to, configuration data, reliability data, health data, performance data, user-entered problem reports, and so on. The server formats the data as a blog for presentation to a user associated with the computing device for which the blog was created.

### BACKGROUND

Computers are used by many people who are not technically skilled at diagnosing and correcting problems that may arise with a computer. Furthermore, many computer users are not even comfortable installing or upgrading applications like anti-virus software, or adjusting security settings like firewall settings. Many of these types of users rely on more knowledgeable friends or family members to assist them with these types of tasks.

It can be very valuable for individuals providing technical assistance to have access to data such as a software installation history, performance history, device installation/removal history, current computer problems, and so on. Unfortunately, there is no central place to get the overall history of a computer and the activities performed on it. Furthermore, if the individual providing technical assistance is trying to help the computer user over the phone, it can be very difficult to walk the computer user through the necessary steps to retrieve some of this helpful information.

### SUMMARY

The Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Automated device blog creation is described. Data associated with a computing device (e.g., performance data, configuration data, health data, or reliability data) is automatically gathered and uploaded. User entered data, such as problem descriptions may also be gathered and uploaded. The gathered data associated with the computing device is automatically formatted as a web log (“blog”), which can then be accessed and easily read by a user of the computing device. A user of the computing device may also grant other users permission to view the device blog, for example, to assist in troubleshooting a problem that the user is having with the computing device.

### BRIEF DESCRIPTION OF THE DRAWINGS

FIG. 1 is a block diagram that illustrates an exemplary network environment in which automated device blog creation may be implemented.

FIG. 2 is a block diagram that illustrates an exemplary network environment in which a blog associated with one computing device can be accessed by a user associated with another computing device.

FIG. 3 is a blog diagram that illustrates an exemplary network environment in which a user is automatically notified of an update to an automatically generated device blog.

FIG. 4 is a block diagram that illustrates an exemplary network environment in which automated device blog creation may be implemented for a collection of computing devices.

FIG. 5 is a pictorial diagram that illustrates a portion of an exemplary device blog that may be automatically generated.

FIG. 6 is a block diagram that illustrates select components of an exemplary computing device for which a blog may be automatically created.

FIG. 7 is a block diagram that illustrates select components of an exemplary web server configured to automatically create device blogs.

FIG. 8 is a flow diagram that illustrates an exemplary method for gathering data at a computing device to support automated device blog creation.

FIG. 9 is a flow diagram that illustrates an exemplary method for automatically generating a blog based on device history data.

FIG. 10 is a flow diagram that illustrates an exemplary method for enabling user access to an automatically generated device blog.

### DETAILED DESCRIPTION

Automated device blog creation as described below provides a mechanism by which history data associated with a computing device is automatically gathered and automatically formatted for presentation to a user. A blog is typically thought of as a web-based journal or diary of sorts, where a user (the blog owner) writes entries. The entries are then typically displayed in chronological order. An automatically created device blog, as described herein, provides various types of data associated with a computing device in an easy-to-read format. While portions of the data may be presented in a chronological order, some portions of the blog may also include non-chronological data. Various types of history data associated with a computing device may be gathered for presentation via a blog. Such history data may include, but is not limited to, performance data, health data, reliability data, configuration data, and user-submitted data.

The following discussion is directed to automated device blog creation. While features of automated device blog creation can be implemented in any number of different computing environments, they are described in the context of the following exemplary implementations.

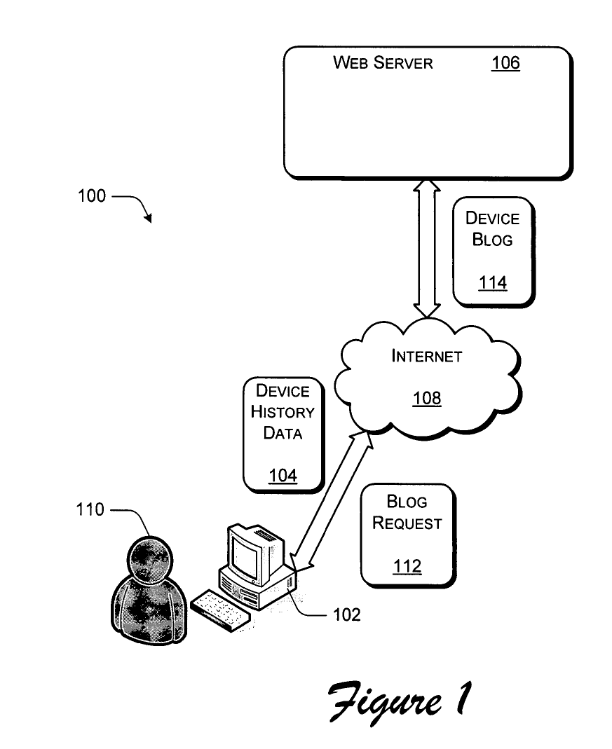

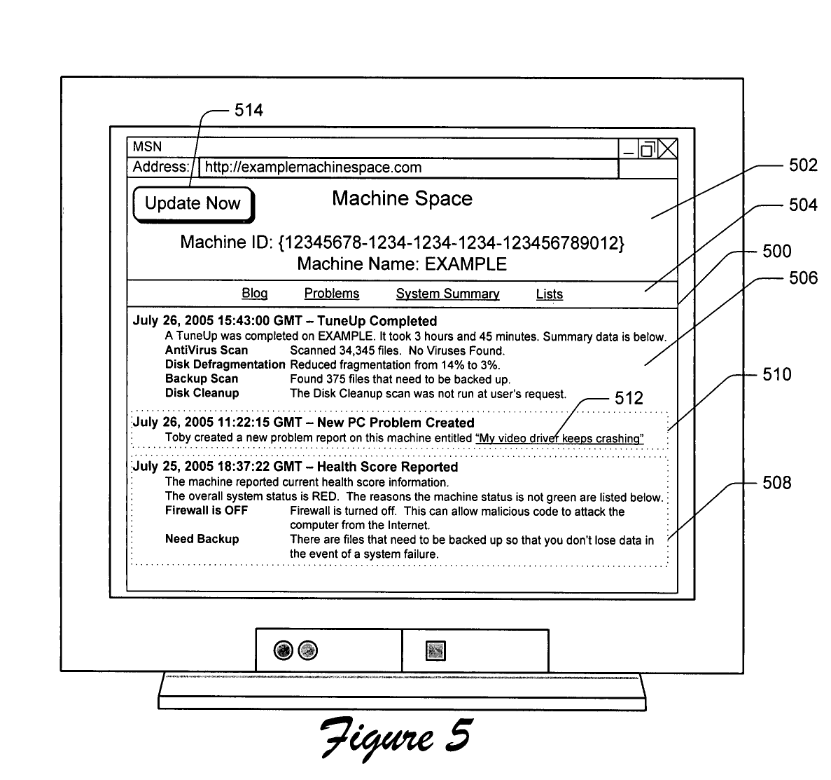

FIG. 1 illustrates an exemplary network environment 100 in which automated device blog creation may be implemented. Computing device 102 gathers device history data 104, and transmits device history data 104 to web server 106 via a network, such as the Internet 108. Web server 106 maintains the device history data 104 for later presentation as a blog. For example, a user 110 of computing device 102 may submit a blog request 112 via the Internet 108 to web server 106. In response to the blog request 112, web server 106 transmits device blog 114 via the Internet 108 to computing device 102. Device blog 114 presents device history data 104 in an easy-to-read format. An example device blog is described in further detail below with reference to FIG. 5.

Web server 106, although illustrated as a single web server, may also be implemented as a combination of one or more servers. For example, device history data 104 may first be uploaded to a server (not necessarily a web server), which is configured to maintain and format the data as a blog. The blog may then be transmitted to a second server (implemented as a web server), which is configured to receive blog request 112, and in response, serve the blog. Accordingly, throughout this document, references to a web server are intended to imply any server or combination of servers that may be configured to provide the described functionality.

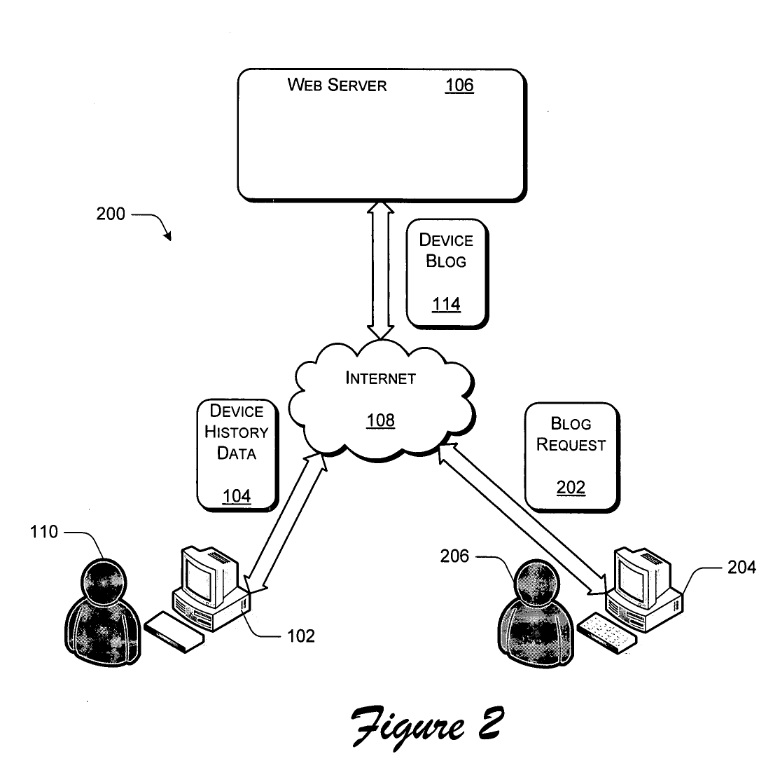

FIG. 2 illustrates an exemplary network environment 200 in which a blog associated with one computing device can be accessed by a user via another computing device. As in FIG. 1, computing device 102 gathers device history data 104, and transmits device history data 104 to web server 106 via the Internet 108. Web server 106 maintains the device history data 104 for later presentation as a blog. In the illustrated implementation, a blog request 202 is submitted from computing device 204 via the Internet 108 to web server 106. If a user 206, who initiated the blog request 202, is authorized to view the blog, then in response to the blog request 202, web server 106 transmits device blog 114 via the Internet 108 to computing device 204.

In an exemplary implementation, a single user of computing device 102 is initially established as the owner of the computing device 102. The owner of the computing device 102 is given default access to the blog, and can specify any number of other users who may also be given access (either permanent or temporary) to the blog.

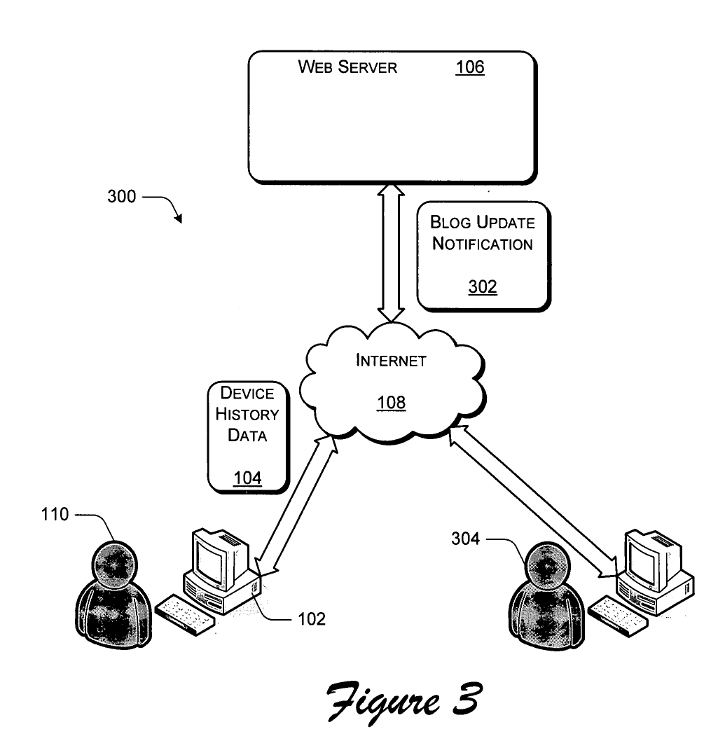

FIG. 3 illustrates an exemplary network environment 300 in which a blog update notification is automatically generated when a device blog is updated. As in FIG. 1, computing device 102 gathers device history data 104, and transmits device history data 104 to web server 106 via the Internet 108. Web server 106 maintains the device history data 104 for later presentation as a blog. In the illustrated implementation, blog update notification 302 is generated and transmitted to user 304. Such an implementation enables user 304 to be notified of any changes in computing system 102. For example, user 304 may be a technical support staff member for a particular company, and computing device 102 may be a company system for which user 304 provides support. Alternatively, computing device 102 may be a personal computer, and user 304 may be a friend of user 110 who has agreed to monitor the computer and recommend any updates that should be installed.

Web server 106 may be implemented to deliver blog update notification 302 in any number of ways. For example, blog update notification 302 may be delivered as an email message, as an instant message, or via a subscription service such as really simple syndication (RSS).

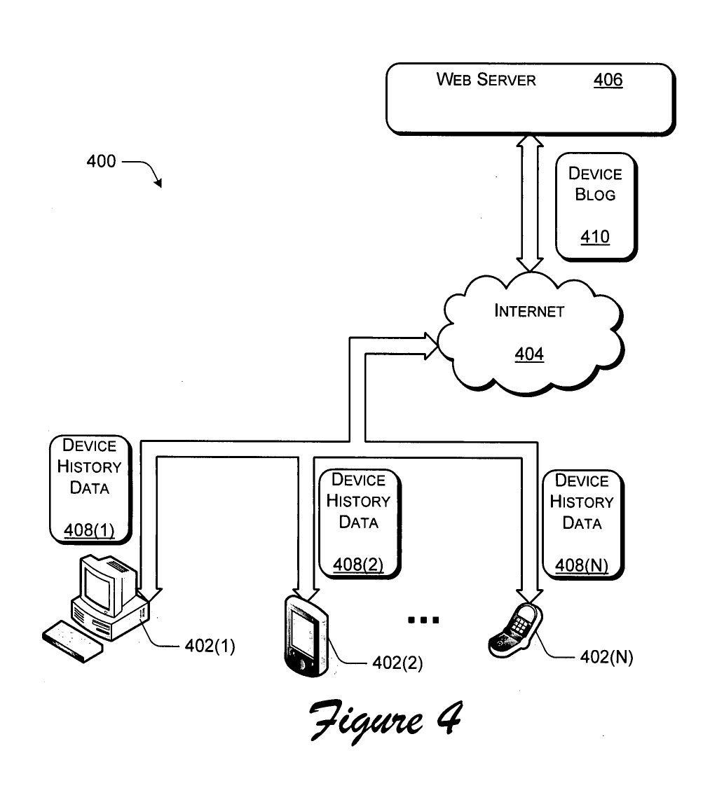

FIG. 4 illustrates an exemplary network environment 400 in which automated device blog creation may be implemented for a collection of computing devices. In the illustrated example, computing devices 402(1), 402(2), . . . and 402(N) are, in some way, related. For example, they may each be owned and operated by the same user, or may be connected to a particular local area network. Device history data is uploaded via the Internet 404 from each of the computing devices 402 to web server 406. For example, device history data 408(1) is uploaded from computing device 402(1); device history data 408(2) is uploaded from computing device 402(2); and device history data 408(N) is uploaded from computing device 402(N). Web server 406 aggregates the device history data from each of the computing devices, and generates device blog 410, which is formatted to provide aggregated history data for all of the related computing devices 402 in an easy-to-read format. Such an implementation may be very useful, for example, to individuals that provide technical support for many devices within a home or business network environment.

Also, as illustrated in FIG. 4, computing devices for which blogs can be automatically created are not limited to personal computers. Rather, blogs may be automatically created for any type of computing device, including, but not limited to, a personal computer, a laptop computer, a server computer system, a portable computing device, a personal digital assistant (PDA), a cell phone, a pocket PC, and any other type of computing device. Any type of Internet-enabled computing device may be configured to support automated device blog creation. Furthermore, a non-Internet enabled computing device may also be configured to support automated device blog creation, if the device can be connected and transmit data to a computing device that is Internet-enabled. For example, a PDA that is not Internet-enabled may be configured to gather device history data. That device history data may then be uploaded to a personal computer during a PDA synching operation. The personal computer may then upload the device history data on behalf of the PDA for creation of a blog associated with the PDA.

FIG. 5 illustrates a portion of an exemplary device blog 500 that may be automatically generated as described herein. Exemplary device blog 500 is presented as a web page (or multiple web pages), and includes device identification area 502, menu area 504, and blog details area 506. Device identification area 502 lists identifying information associated with the computing device for which the blog has been created. Menu area 504 includes links to other portions of the blog, which may display portions of the device history data in different formats. Blog details area 506 lists the blog entries generated from the device history data. For example, blog entry 508 indicates that on Jul. 25, 2005, the computing device reported a health score. The details of the entry indicate that the device firewall is not turned on and that some data has not been backed up. Blog entry 510 indicates that on July 26, a user (i.e., “Toby”) reported that the device's video driver has been crashing. Blog entry 510 includes a link 512 to another page of the blog that includes more information associated with the reported problem. The other page may include some interactive user interface elements that, for example, enable a user to request various real-time statistics from the device to help diagnose or correct the problem.

Referring back to menu area 504, selecting the problems link may cause another web page to be displayed that presents a list of user-submitted problems. Similarly, selecting the system summary link may cause another web page to be displayed that lists the most currently gathered status data associated with the computing device. Such status data may include, for example, the current status of any installed firewall, antivirus, or antispyware software. Selecting the lists link may cause yet another web page to be displayed that includes any number of data lists, which may include, but are not limited to, a list of the last five crashes/hangs, a list of user-reported problems, a list of system boot times, a list of software installed on the machine, and/or a list of software configured for automatic startup. Device blog 500 may also include update now button 514. When selected, update now button 514 causes the web server to request that the computing device associated with the blog perform a data upload, even if the computing device is not currently scheduled to upload data. In this way, the blog can be updated with the most current data available. This may be useful when a user is trying to modify settings or correct a problem, in that the user could make changes to the computing device, and then update the blog to determine how the changes have affected the status of the computing device.

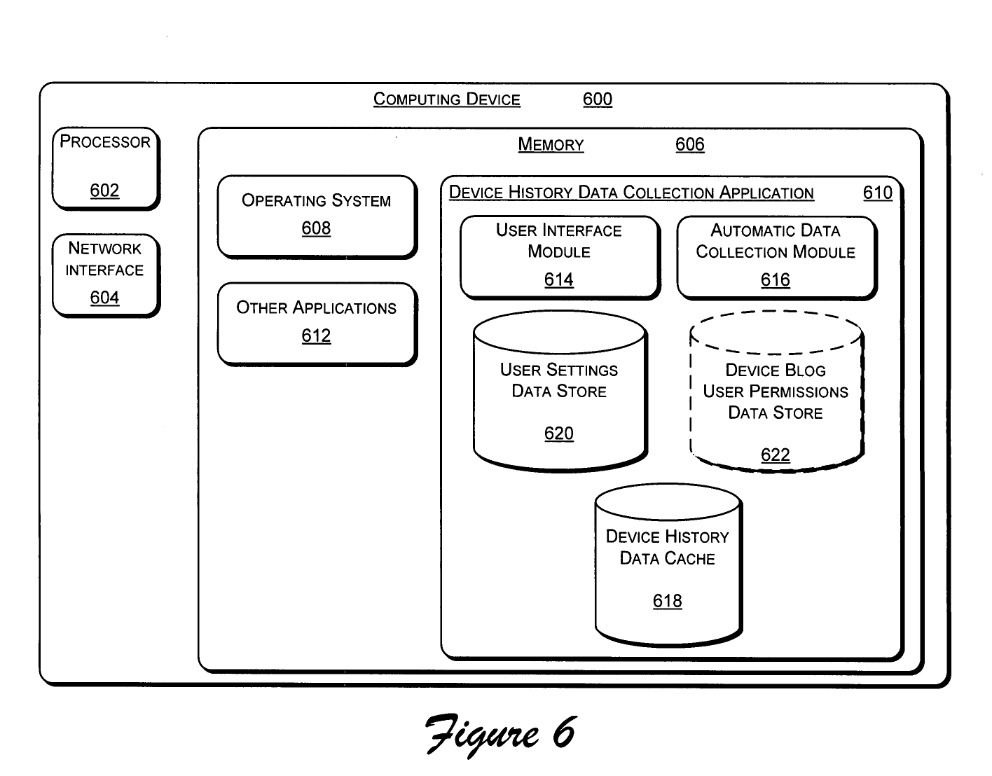

FIG. 6 illustrates select components of an exemplary computing device 600 configured to support automated device blog creation. Computing device 600 includes processor 602, network interface 604 and memory 606. Network interface 604 enables computing device 600 to transmit data to a web server via the Internet. Alternatively, rather than having network interface 604, computing device 600 may have another type of interface that enables the computing device 600 to communicate with another type of computing device that includes a network interface. Operating system 608, device history data collection application 610, and any number of other applications 612 are stored in memory 606 and executed on processor 602. Memory 606 is representative of any type or combination of memory, such as, but not limited to, random access memory (RAM), a hard disk, or removable memory media.

Exemplary device history data collection application 610 includes user interface module 614, automatic data collection module 616, device history data cache 618, and user settings data store 620. User interface module 614 enables user interaction with device history data collection application 610. For example, a user may, through user interface module 614, specify various user settings, which are maintained in user settings data store 620. The user settings may, for example, specify types of data to be collected, data collection frequencies, and data upload frequencies.

Automatic data collection module 616 automatically gathers various types of data associated with computing device 600, typically (but not necessarily) running as a background process. For example, when computing device 600 is powered on, device history data collection application 610 may be launched to run as a background process. The data to be gathered may be pre-set or may be specified by data in user settings data store 620. The data that is gathered is written to device history data cache 618. Examples of data that may be gathered (either by default or based on user settings) may include, but is not limited to, startup performance data (i.e., how long it takes for the computer to boot), computer health ratings (e.g., antivirus status, firewall status, antivirus signatures status, antispyware status, data backup status, disk defragmentation needed, etc.), computer reliability data (e.g., how many times has the machine rebooted during a particular time period, why the machine has been rebooted, how many times the machine has crashed during a particular time period, what has caused system crashes, etc.), software patches available, performance measurements (e.g., memory speed, disk speed, processor speed, video card speed, etc.), configuration data (e.g., brand/model of different hardware components such as the motherboard, central processing unit, mouse, keyboard, video card, etc.), software installation history data (e.g., which apps are installed on the computing device, when applications were added and/or removed from the computing device), and startup group data (e.g., a listing of applications that are started automatically each time a user logs on). User reported problems may be gathered as text entries typed in by the user via a user interface associated with the device history data collection application. User reported problems may include entries such as, “my machine is slow”, “Outlook isn't getting mail from my ISP”, “how do I use pivot tables in Excel?”, and so on. Data stored in device history data cache 618 is uploaded to a web server periodically (e.g., hourly, daily, weekly, or by request).

A user may also specify one or more other users who are to be granted permission to view and/or interact with a blog associated with computing device 600. Such user permissions are typically maintained by a web server that manages access to the blog. In an exemplary implementation, a user may access and modify the permissions associated with a blog through an interface with the web server. Alternatively, device history data collection application 610 may also include device blog user permissions data store 622. In such an implementation, device blog user permissions data store 622 maintains a copy of the user permissions that are maintained by the web server. A user may modify the permissions as maintained by device blog user permissions data store 622, and those modifications may then be uploaded to the web server along with data from device history data cache 618.

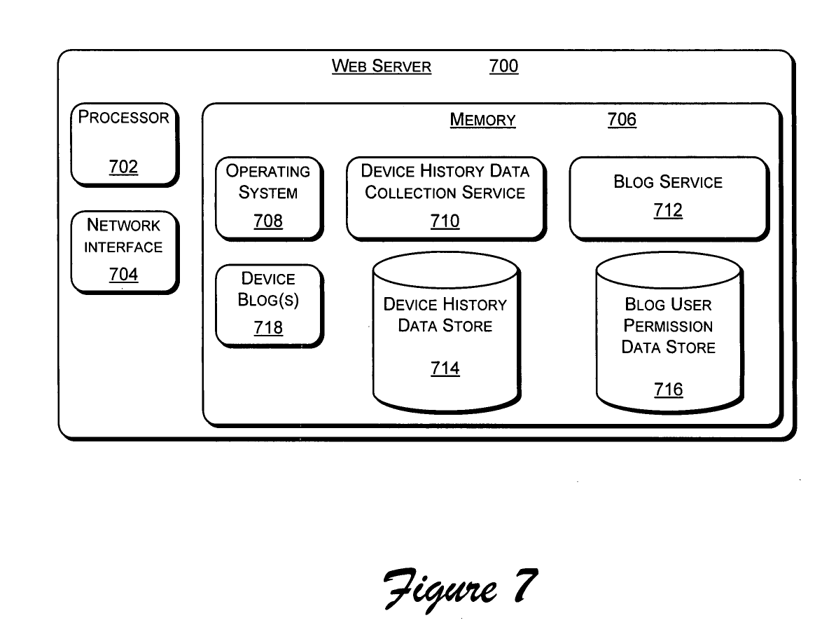

FIG. 7 illustrates select components of an exemplary web server 700 configured to support automated device blog creation. As described above with reference to FIG. 1, although shown as a single device, web server 700 may represent any number of servers, which, when taken as a whole, provide the functionality described. Web server 700 includes processor 702, network interface 704, and memory 706. Network interface 704 enables web server 700 to transmit and receive data via the Internet. Operating system 708, device history data collection service 710, and blog service 712 are stored in memory 706 and executed on processor 702. Memory 702 represents any type or combination of memory devices, such as, but not limited to, RAM, a hard disk, or removable memory media.

Device history data collection service 710 receives history data and user permissions data uploaded from one or more computing devices. Device history data collection service 710 writes the received history data to device history data store 714 and updates blog user permission data store 716 with the received user permissions data. Blog service 712 uses the data stored in device history data store 714 to create or update the device blog 718 associated with a computing device from which history data has been received. Blog service 712 also receives blog requests from users. When a particular blog is requested, blog service 712 accesses blog user permission data store 716 to verify that the requesting user has permission to access the requested blog. Due to the sensitive nature of the data that may be stored in a device blog, this security measure is very important. For example, if no control was exercised over who was granted access to device blogs, a hacker could access the device blogs to easily identify, for example, computing devices with no firewall protection or outdated antivirus signatures.

In an exemplary implementation, blog service 712 may also be configured to automatically generate and deliver a notification when a particular device blog is updated. For example, as described above with reference to FIG. 3, a particular user may wish to be notified when a particular device blog is updated. Alternatively, the user may wish to be notified only when certain types of data in the device blog is updated. For example, the user may wish to be notified any time a user manually reports a problem. In such an implementation, blog user permission data store may include data that indicates which users wish to receive automatic notifications, and the circumstances under which those notifications should be delivered.

Methods for implementing automated device blog creation may be described in the general context of computer executable instructions. Generally, computer executable instructions include routines, programs, objects, components, data structures, procedures, and the like that perform particular functions or implement particular abstract data types. The methods may also be practiced in a distributed computing environment where functions are performed by remote processing devices that are linked through a communications network. In a distributed computing environment, computer executable instructions may be located in both local and remote computer storage media, including memory storage devices.

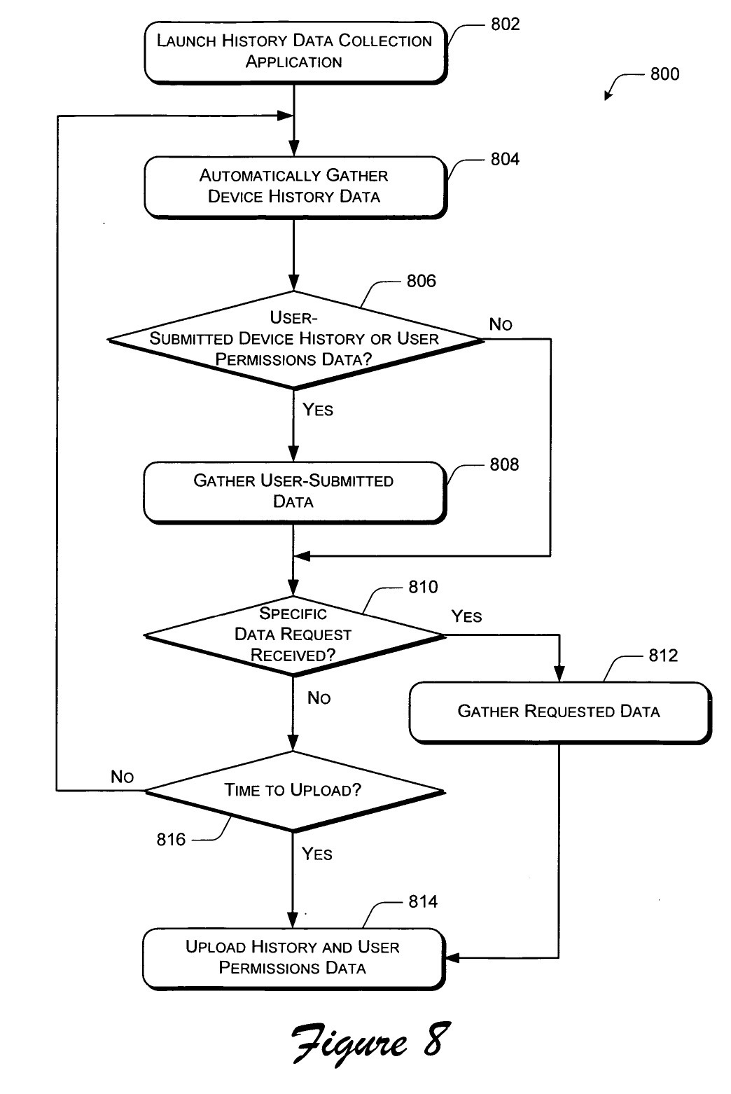

FIGS. 8-10 illustrate exemplary methods to support automated device blog creation. FIGS. 8-10 are specific examples of automated device blog creation, and are not to be construed as limitations. The order in which the methods are described is not intended to be construed as a limitation, and any number of the described method blocks can be combined in any order to implement the method. Furthermore, the methods can be implemented in any suitable hardware, software, firmware, or combination thereof.

FIG. 8 illustrates an exemplary method 800 for gathering data at a computing device to support automated device blog creation. At block 802, a history data collection application is launched. For example, when a computing device 600 is powered on, device history collection application 610 is launched as a background application. In alternate implementations, device history collection application 610 may be launched in other ways, for example, as a foreground application.

At block 804, device history data is automatically gathered. For example, automatic data collection module 616 gathers various types of data associated with computing device 600 and records the gathered data in device history data cache 618.

At block 806, it is determined whether or not user-submitted device history data or user-submitted user permissions data has been received. For example, device history data collection application 610 determines whether or not a user has submitted a problem report via user interface module 614 or whether or not a user has updated data stored in device blog user permissions data store 622.

If no user-submitted device history or user permissions data has been received (the “No” branch from block 806), then processing continues as described below with reference to block 810. On the other hand, if user-submitted device history data or user permissions data has been received (the “Yes” branch from block 806), then at block 808, the user-submitted data is gathered. For example, any user-submitted device history data received through user interface module 614 is written to device history data cache 618, and any user-submitted user permissions data is used to update device user permissions data store 622.

At block 810, it is determined whether or not a request to gather specific data has been received. For example, a user may submit a request through user interface module 614 for specific data to be gathered and uploaded immediately. Similarly, an individual viewing the device blog may submit a request for updated data through an interactive portion of the blog, causing a request for data to be sent from the web server to the computing device.

If a request to gather specific data has been received (the “Yes” branch from block 810), then at block 812, the requested data is gathered. For example, the requested data is automatically gathered and added to device history data cache 618.

At block 814, history data and user permissions data is uploaded. For example, computing device 600 transmits data from device history data cache 618 and device blog user permissions data store 622 over the Internet to a web server.

On the other hand, if it is determined that no requests to gather specific data have been received (the “No” branch from block 810), then at block 816, it is determined whether or not it is time to upload the device history data. For example, device history data collection application 610 may be preset to automatically upload data at specified intervals. Alternatively, device history data collection application 610 may receive instructions indicating a request that any data currently in the device history data cache 618 be uploaded.

If it is determined that it is not yet time to upload the device history data (the “No” branch from block 816), then processing continues as described above with reference to block 804. On the other hand, if it is determined that it is time to upload the device history data (the “Yes” branch from block 810), then at block 814, history data and user permissions data is uploaded. For example, computing device 600 transmits data from device history data cache 618 and device blog user permissions data store 622 over the Internet to a web server.

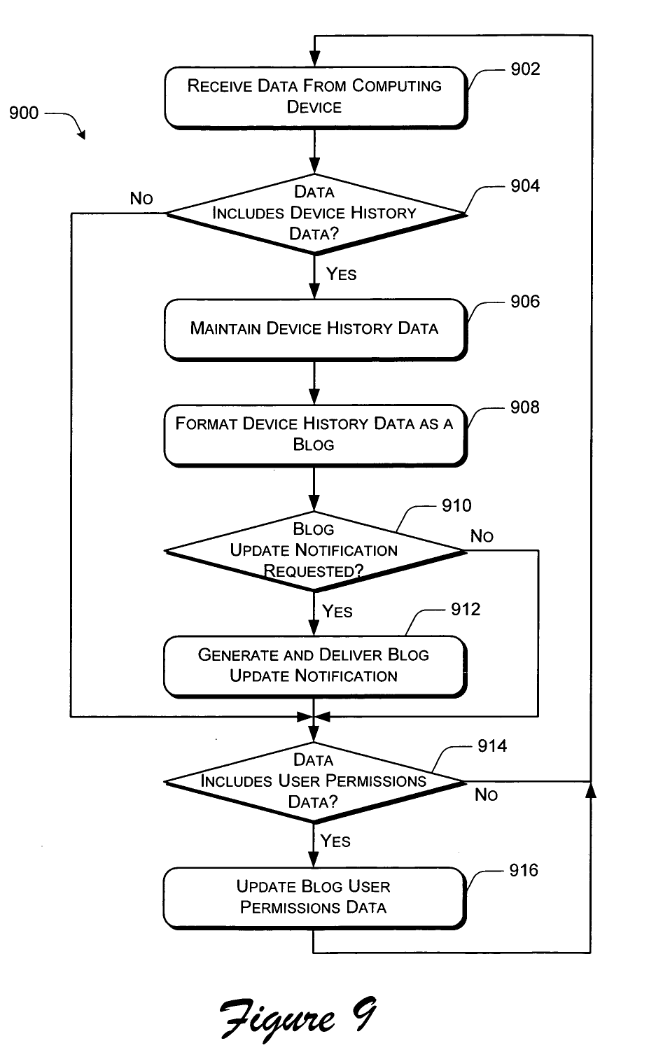

FIG. 9 illustrates an exemplary method 900 for generating a blog based on device history data. At block 902, data is received from a computing device. For example, web server 700 receives data via the Internet from a computing device.

At block 904, it is determined whether or not the received data includes device history data. For example, device history data collection service 710 determines whether or not the received data includes history data associated with the device from which the data was received.

If it is determined that the received data does not include device history data (the “No” branch from block 904), then processing continues as described below with reference to block 914. If it is determined that the received data does include device history data (the “Yes” branch from block 904), then at block 906, the received device history data is maintained. For example, device history data collection service 710 writes the received device history data to device history data store 714.

At block 908, the received device history data is formatted as a blog. For example, blog service 712 accesses the data stored in device history data store 714, and creates or updates a device blog 718 associated with the device.

At block 910, it is determined whether or not a blog update notification has been requested. For example, blog service 712 examines data in blog user permission data store 716 to determine whether or not any users with permission to access the device blog have requested to be notified when the blog is updated.

If it is determined that no blog update notifications have been requested (the “No” branch from block 910), then processing continues as described below with reference to block 914. On the other hand, if it is determined that a blog update notification has been requested (the “Yes” branch from block 910), then at block 912, a blog update notification is generated and delivered. For example, blog service 712 generates a notification and transmits it to any users who have requested such notification. The notification may be delivered, for example, via email, as an instant message, or as an RSS notification.

At block 914, it is determined whether or not the received data includes user permissions data. If the received data does not include user permissions data (the “No” branch from block 914), then processing continues as described above with reference to block 902.

If it is determined that the received data does include user permissions data (the “Yes” branch from block 914), then at block 916, blog user permissions data is updated. For example, device history data collection service 710 updates blog user permission data store 716 using the received user permission data. It is recognized that in an alternate implementation, blog user permissions data may be updated by a user through a web page interface rather than via the uploaded data, as described here. Processing then continues as described above with reference to block 902.

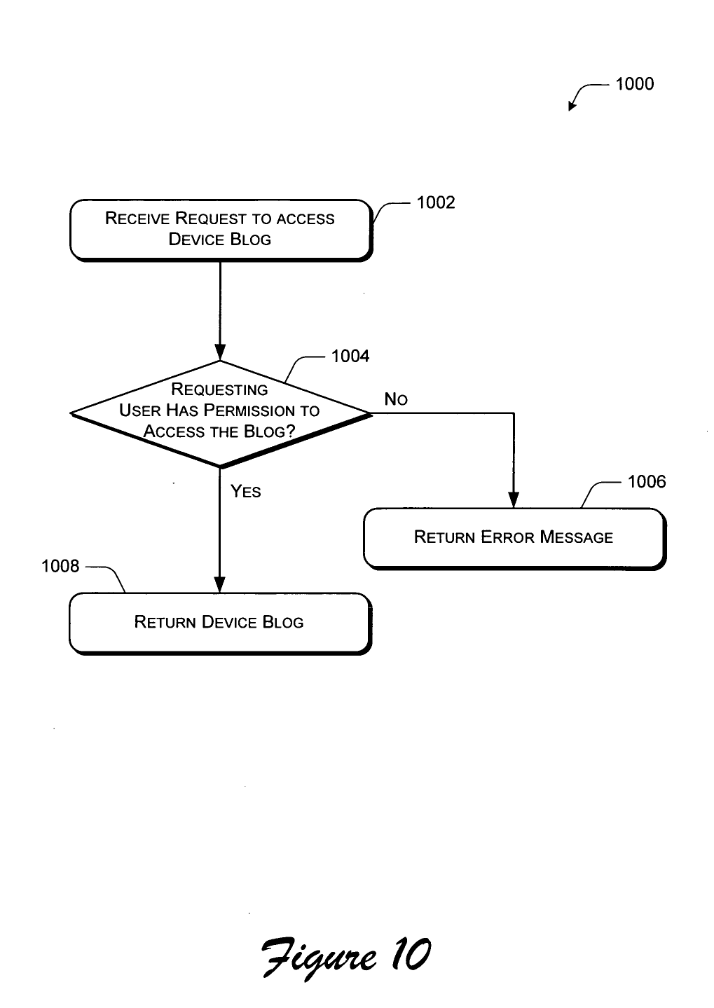

FIG. 10 illustrates an exemplary method 1000 for enabling user access to an automatically generated device blog. At block 1002, a request to access a device blog is received. For example, blog service 712 receives a request to access a particular device blog.

At block 1004, it is determined whether or not the user requesting access to the device blog has permission to access the blog. For example, blog service 712 compares a user identifier associated with the request with data stored in blog user permission data store 716 to determine if the requesting user has permission to access the requested device blog.

If the requesting user does not have permission to access the requested device blog (the “No” branch from block 1004), then at block 1006, an error message is returned. On the other hand, if the requesting user does have permission to access the requested device blog (the “Yes” branch from block 1004), then at block 1008, the requested device blog is returned.

Although embodiments of automated device blog creation have been described in language specific to structural features and/or methods, it is to be understood that the subject of the appended claims is not necessarily limited to the specific features or methods described. Rather, the specific features and methods are disclosed as, exemplary implementations of automated device blog creation.

1. A computer-implemented method comprising:
receiving data associated with a remote computing device; and
automatically formatting the data for presentation to a user.

2. The method as recited in claim 1, wherein automatically formatting the data for presentation to a user comprises formatting the data as a chronological web log (blog).

3. The method as recited in claim 1, wherein the data associated with the remote computing device comprises at least one of computing device performance data, computing device health data, computing device reliability data, computing device configuration data, or software data.

4. The method as recited in claim 3, wherein the computing device performance data comprises at least one of a computer boot time, memory speed, disk speed, processor speed, network speed, or video card speed.

5. The method as recited in claim 3, wherein the computing device health data comprises at least one of antivirus status, firewall status, firewall policy update status, antivirus signature update status, antispyware status, data backup status, or disk fragmentation status.

6. The method as recited in claim 3, wherein the computing device reliability data comprises at least one of a number of computing device reboots, a reboot reason, a number of computing device crashes, a crash reason, disk health status data, a SMART disk failure notification, a potential invalid cluster layout notification, or a bad disk notification.

7. The method as recited in claim 3, wherein the computing device configuration data comprises at least one of a motherboard brand, a motherboard model, a central processing unit brand, a central processing unit model, a mouse brand, a mouse model, a keyboard brand, a keyboard model, a video card brand, or a video card model.

8. The method as recited in claim 3, wherein the software data comprises at least one of operating system data, an operating system version, an operating system patch status, a software patch installation status, product update version status, software install report, software uninstall report, or a start group program listing.

9. The method as recited in claim 1, wherein the data associated with the remote computing device comprises a user-entered problem report.

10. The method as recited in claim 1, further comprising:
receiving permissions data indicating a user that should be granted access to the data associated with the remote computing device;
receiving from the user a request to access the data associated with the remote computing device; and
providing the user with access to the data associated with the remote computing device.

11. The method as recited in claim 1, further comprising:
identifying a notification request associated with the remote computing device;
automatically generating a notification; and
transmitting the notification based on the notification request.

12. The method as recited in claim 11, wherein the notification request identifies a user to be notified when data associated with the remote computing device is updated.

13. The method as recited in claim 11, wherein transmitting the notification comprises sending at least one of an email, an instant message, a direct socket communication, an HTTP polling response, an XML web service polling response, an automated telephone call, a telephone text message, a beeper message, or a really simple syndication (RSS) message.

14. A web-based system comprising:
a device history data collection service configured to receive data associated with a remote computing device;
a user permission data store configured to maintain data that identifies one or more users to whom access to the data associated with the remote computing device is to be granted; and
a blog service configured to format the received data for presentation to any of the one or more users.

15. The web-based system as recited in claim 14, wherein the device history data collection service is further configured to:
receive user permissions data identifying a user who is to be granted access to the data associated with the remote computing device; and
update the user permission data store based on the received user permissions data.

16. The web-based system as recited in claim 14, wherein the device history data collection service is further configured to receive a notification request identifying a user who is to be notified when data associated with the remote computing device is updated.

17. The web-based system as recited in claim 14, wherein the blog service is further configured to automatically notify a user that data associated with the remote computing device has been updated.

18. One or more computer-readable media comprising computer-readable instructions which, when executed, cause a computer system to:
receive data associated with the performance, health, reliability, or configuration of a remote computing device; and
format the received data as a blog.

19. The one or more computer-readable media as recited in claim 18, further comprising computer-readable instructions which, when executed, cause the computer system to:
identify a user who is to be notified of updates to the blog;
generate a blog update notification; and
transmit the blog update notification to the user.

20. The one or more computer-readable media as recited in claim 18, further comprising computer-readable instructions which, when executed, cause the computer system to:
receive a request to access the blog from a user;
determine whether or not the user has permission to access the blog; and
in an event that the user has permission to access the blog, provide the user with access to the blog.
